(19) United States
(12) Patent Application Publication
(10) Pub. No.: US 2015/0251505 A1
(43) Pub. Date: Sep. 10, 2015

(54) HITCH ASSEMBLY AND METHOD OFCOUPLING CARTS USING THE HITCH ASSEMBLY

(71) Applicants: Marty Rodda, Pell City, AL (US); Darin Clayton, Southside, AL (US); Brandon Wailes, Anniston, AL (US)

(72) Inventors: Marty Rodda, Pell City, AL (US); Darin Clayton, Southside, AL (US); Brandon Wailes, Anniston, AL (US)

(73) Assignee: HONDA MOTOR CO., LTD., Tokyo (JP)

(21) Appl. No.: 14/196,476

(22) Filed: Mar. 4, 2014

(51) Int. Cl. B60D 1/02

(52) U.S. Cl. CPC B60D 1/025

(57) ABSTRACT

A hitch assembly includes a frame including a base. A first plate extending from the base defines a first opening. A second plate extending from the base defines a second opening coaxially aligned with the first opening. A sleeve is coupled to the first plate and includes a cylindrical wall defining a passage coaxially aligned with the first opening. The sleeve further defines a first notch and a second notch displaced along a circumference of the wall from the first notch. The first notch and the second notch extend from a first end of the sleeve parallel with the axis. A pin having an alignment post extending radially outwardly from the pin is movably positioned within the passage to position the alignment post in the first notch or the second notch. Methods of connecting an incoming cart to a hitch assembly of a first cart are also disclosed.

### BACKGROUND

The present disclosure generally relates to a hitch assembly and, more particularly, to a hitch assembly coupled to a first cart that includes a movable pin for engaging a tongue of a second cart to connect the second cart to the first cart, for example.

It is known that trailer hitch couplers may include a pin configured to be coupled with a tongue of a cart. This pin is held in place either manually by a user or through the use of a locking mechanism for maintaining the pin in an open position.

In the instance where a user is required to manually hold the pin in an open position, the user must hold the pin in the open position with one hand, position the tongue of the incoming cart at a proper height with the user's foot, and then pull the incoming cart with the user's remaining hand to properly position the tongue on the hitch coupler so that the pin can be released to couple the carts together. As such, the user is required to properly position two carts while having only one foot on the ground for stability and a single hand on each cart for positioning.

It is also known that a locking mechanism can be used for maintaining a pin in a retracted, open position. For example, one conventional hitch coupler includes a pin that is biased towards a locked position but also includes a mechanism to maintain the pin in a position that allows insertion of a tongue. The pin can be secured in the retracted position, however, this requires aligning the pin with a keyhole and then pulling the pin up vertically through the keyhole opening before resting the pin against a flange. As such, the user is required to align the pin with the keyhole before being able to place the pin in an open position.

Accordingly, many conventional methods of coupling carts are not only complicated but also extremely difficult for a single person to accomplish. Therefore, there exists a need for a coupling assembly that is more user-friendly than prior art hitch couplers.

### SUMMARY

In one aspect, a hitch assembly includes a frame having a base plate, a first plate defining a first opening wherein the first plate extends from a top portion of the base plate, a second plate defining a second opening wherein the second plate extends from a middle portion of the base plate, and a third plate defining a third opening wherein the third plate extends from a bottom portion of the base plate. The first opening, the second opening, and the third opening are coaxially aligned. A pin having a handle and an alignment post extending radially outwardly from the pin is configured to be inserted through the first opening, the second opening, and the third opening. A sleeve is coupled to the first plate and defines a first notch and a second notch, wherein the first notch has a first length and the second notch has a second length different than the first length.

In another aspect, a hitch assembly includes a frame including a base having a first edge portion and an opposing second edge portion. A first plate extends from the first edge portion of the base and defines a first opening. A second plate extends from the second edge portion of the base and defines a second opening coaxially aligned with the first opening. A sleeve is coupled to the first plate. The sleeve includes a cylindrical wall defining a passage along an axis of the sleeve between a first end of the sleeve and an opposing second end of the sleeve. The passage is coaxially aligned with the first opening. The sleeve further defines a first notch through the wall that extends from the first end of sleeve parallel with the axis and a second notch displaced along a circumference of the wall from the first notch and extending through the wall. The second notch extends from the first end of sleeve parallel with the axis and has a length different than a length of the first notch. A pin includes an alignment post extending radially outwardly from the pin. The pin is movably positioned within the passage to position the alignment post in one of the first notch and the second notch.

In another aspect, a method of connecting an incoming cart to a hitch assembly coupled to a first cart is provided. The hitch assembly includes a frame having a base plate, a first plate extending from the base plate defining a first opening, a second plate extending from the base plate defining a second opening, and a third plate extending from the base plate defining a third opening coaxially aligned with the first opening and the second opening, and a sleeve coupled to the first plate and defining a passage coaxially aligned with the first opening. The method includes moving a pin within the passage to a first position wherein an alignment post extending radially outwardly from the pin is retained within a first notch defined at a free end of the sleeve, in the first position the pin extending through the first opening and the second opening. A tongue of the incoming cart is positioned between the second plate and the third plate. The pin is moved with respect to the sleeve to remove the alignment post from within the first notch and rotated with respect to the sleeve to align the alignment post with a second notch defined at the free end of the sleeve, wherein the second notch having a length greater than a length of the first notch. The pin is moved within the passage to a second position wherein the alignment post is retained within the second notch. In the second position, the pin extends through the first opening, the second opening, and the third opening to connect the incoming cart to the hitch assembly.

### DESCRIPTION OF THE DRAWINGS

FIG. 1 is a side elevational view of an exemplary hitch assembly according to a first embodiment showing a pin in a closed position;

FIG. 2 is a front elevational view of the hitch assembly of FIG. 1;

FIG. 3 is an exploded isometric view of the hitch assembly of FIG. 1;

FIG. 4 is a rear elevational view of the hitch assembly of FIG. 1 showing the pin in the closed position;

FIG. 5 is an isometric view of the hitch assembly of FIG. 1 showing the pin in the closed position;

FIG. 6 is an isometric view of an exemplary sleeve of the hitch assembly of FIG. 1;

FIG. 7 is an isometric view of an exemplary sleeve of the hitch assembly according to an alternate embodiment;

FIG. 8 is an isometric view of an exemplary pin of the hitch assembly of FIG. 1;

FIG. 9 is a side elevational view of a hitch assembly according to a second embodiment showing a pin in a locked position;

FIG. 10 is a front elevational view of the hitch assembly of FIG. 9;

FIG. 11 is a side elevational view of a hitch assembly according to a third embodiment showing a pin in a locked position;

FIG. 12 is a front elevational view of the hitch assembly of FIG. 11;

FIG. 13 is a side elevational view of the hitch assembly of FIG. 1 showing a first cart, a tongue of a second cart and a pin in an open position; and

FIG. 14 is a side elevational view of the hitch assembly of FIG. 1 showing a first cart, a tongue of a second cart and a pin in a closed position.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

In one embodiment, a hitch assembly includes a pin and a cooperating sleeve which enables a user to maintain the hitch assembly in an open position to facilitate coupling the hitch assembly to an incoming cart. This cart can be either powered by an external power source or non-powered and manually moved by a user. It should be noted that the term “cart” as used herein can refer to any apparatus similar to a cart which can be moved manually or with an external power source. The pin includes an alignment post configured to be selectively positioned within a first notch and a second notch defined within the sleeve. With the alignment post positioned within first notch defined in the sleeve, the hitch assembly is locked or retained in an open position and with the alignment post positioned within the second notch, the hitch assembly is locked or retained in a closed position.

In one embodiment, a tongue of an incoming cart and a base area of the hitch assembly are positioned at predetermined heights to eliminate the need for the user to adjust a height of the tongue for alignment with the hitch assembly. In operation, the user positions the alignment post in the first notch which holds the pin in the open position. The user aligns the tongue of the cart with the hitch assembly and lifts the pin to remove the alignment post from within the first notch. The pin is rotated to align the alignment post with the second notch. As the alignment post enters the second notch, at least one of gravity, force provided by a user, and/or force provided by a biasing device urges the pin to a closed position to couple the carts together.

By maintaining the pin in an open position, both hands of the user are free to more easily position the tongue of a first cart into the hitch assembly of a second cart. Furthermore, embodiments of the hitch assembly include a relatively larger base area to more easily accept the tongue of the incoming cart. The alignment post and notched sleeve combination and the larger base area of the hitch assembly enable the user to keep both feet firmly on the ground while using both hands to position the incoming cart without having to hold the hitch assembly.

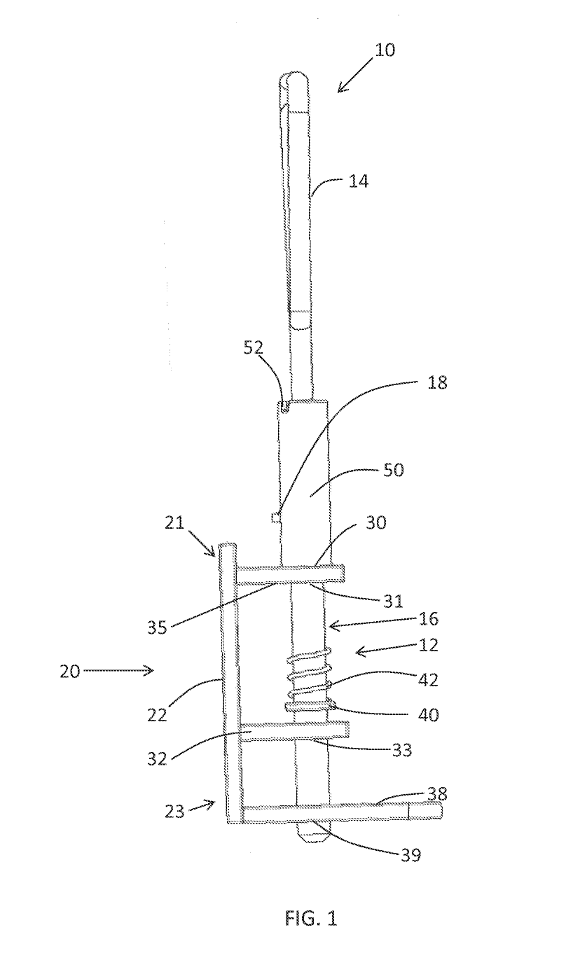

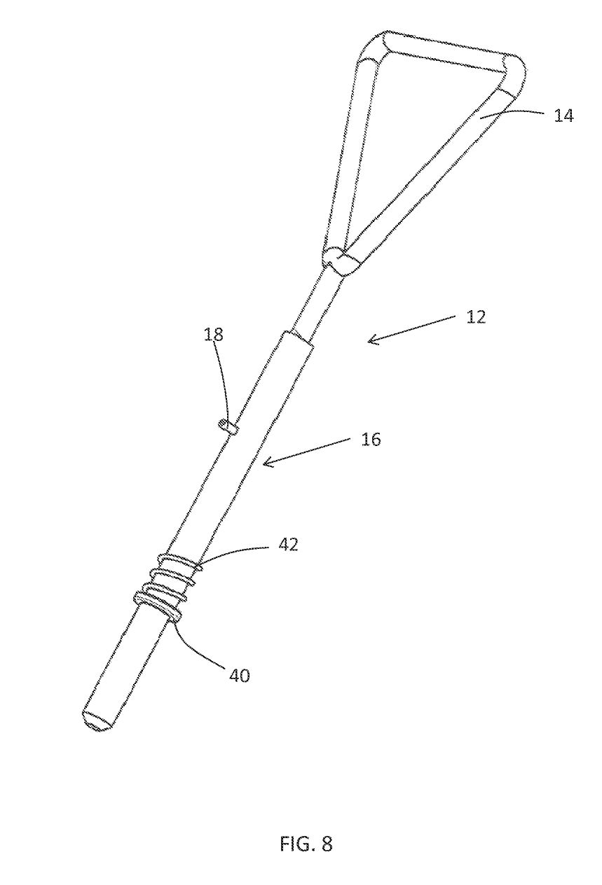

FIG. 1 shows an exemplary embodiment of a hitch assembly 10. In this embodiment, the hitch assembly 10 includes a pin 12 having a handle 14 disposed at a first or upper end to facilitate moving the pin 12. The pin 12 can also include a chamfered edge at a second or lower end to facilitate positioning of the pin 12. In certain embodiments, the pin 12 has a constant diameter along a length of the pin 12. In an alternative embodiment, a shaft 16 of the pin 12 has a cross-sectional diameter greater than a cross-sectional diameter of the pin 12 at or near the handle 14. As shown best in FIG. 8, the pin 12 also includes an alignment post 18 located along a shaft 16 of the pin. As described further below, the alignment post 18 is used to lock the pin 12 into an open position or a closed position. In this embodiment, the alignment post 18 extends radially outward from the pin 12. The pin 12 engages a frame 20.

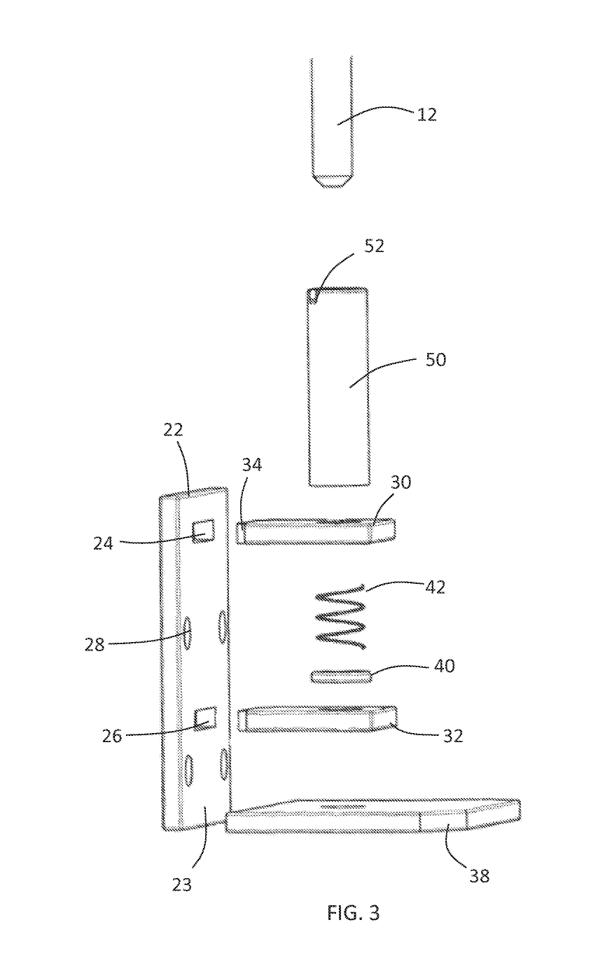

In one embodiment, the frame 20 has an E-shaped profile and includes a base plate 22 and one or more plates extending from the base plate. As seen in FIG. 3, the base plate 22 has a first opening 24 and a second opening 26 which are sized to accept a first plate 30 and a second plate 32, respectively. The first plate 30 includes a protrusion 34 and the second plate 32 includes a protrusion 36. The first opening 24 is sized to accept the protrusion 34 and the second opening 26 is sized to accept the protrusion 36. In one embodiment, the first plate 30 and the second plate 32 are fixedly attached to the base plate 22 using screws or other suitable fasteners known in the art. However, in an alternative embodiment, the first plate 30 and the second plate 32 can be integrated with, directly attached to or welded onto the base plate 22. This would eliminate the need for the first plate 30 and the second plate 32 to have protrusions which are positioned with respective openings defined in the base plate 22.

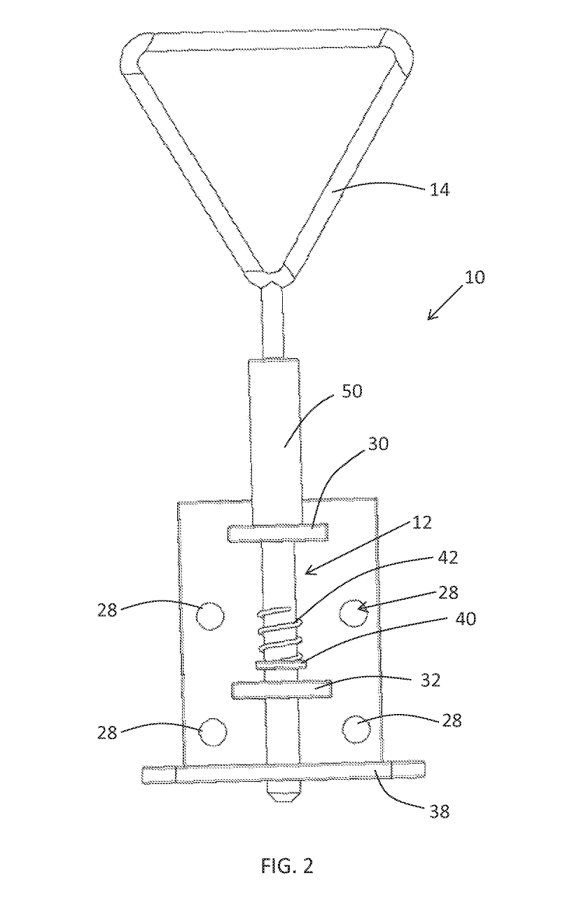

The frame 20 also includes a third plate 38 fastened to the base plate 22. In one embodiment, the base plate 22 includes a third opening (not shown) sized to accept a protrusion of the third plate 38. However, in another embodiment, the third plate 38 does not have a protrusion and is coupled directly or welded to or integrated with a first face 23 of the base plate 22. In one embodiment, the third plate 38 has an increased base area to more easily accept the tongue of an incoming cart. Further, as shown in FIGS. 2-5, the base plate 22 also includes openings 28 which allow the base plate 22 to attach to a cart. The base plate 22 can be attached to a cart through openings 28 through the use of any suitable fasteners known in the art.

The first plate 30, the second plate 32 and the third plate 38 define coaxially aligned openings 31, 33, and 39, respectively, which are sized to accept a shaft 18 of the pin 12. The pin 12 is sized and configured to be inserted through openings 31, 33, and 39. In a particular embodiment, the openings 31, 33, and 39 allow a suitable tolerance for a circumference of the shaft 18 of the pin 12.

In one embodiment, the second plate 32 and the third plate 38 have suitable dimensions to allow the receipt of a tongue of a hitch (not shown) or other suitable member which is intended to be attached to the hitch assembly 10. In this embodiment, a distance between the second plate 32 and the third plate 38 allows some tolerance for a height of the tongue of the hitch or other member, for example.

In one embodiment, the hitch assembly 10 optionally includes a washer 40 and/or a biasing element, such as a spring 42 or other suitable biasing element, which limits an upward travel of the pin 12 relative to the frame 20. As shown in FIGS. 1-3 and 5, the washer 40 and the spring 42 are positioned about the pin 12 and between the first plate 30 and the second plate 32. The washer 40 defines an opening larger than the opening 31 in the first plate 30 and is positioned about the pin 12 to prevent or limit movement of the pin 12 with respect to the frame 20. The washer 40 is located at a first end of the spring 42. The spring 42 is located between the washer 40 and a bottom surface 35 of the first plate 30. When a user lifts up on the pin 12, the spring 42 is compressed between the washer 40 and the bottom surface 35 of the first horizontal plate 30, biasing the pin 12 in an opposite downward direction.

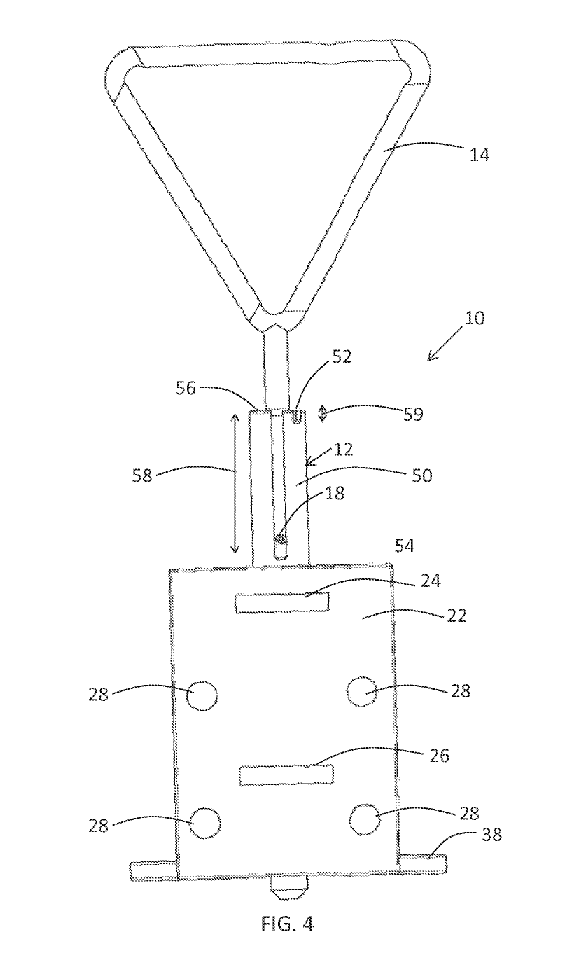

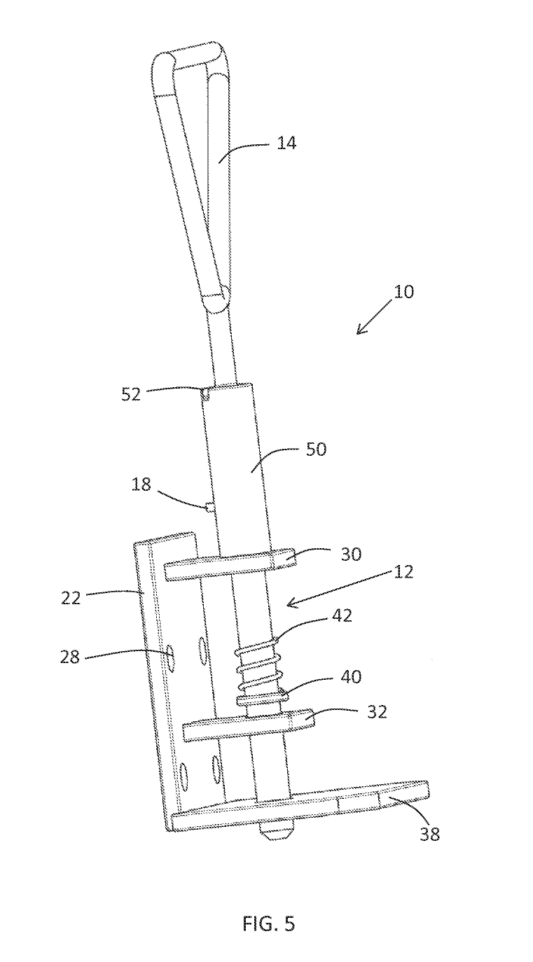

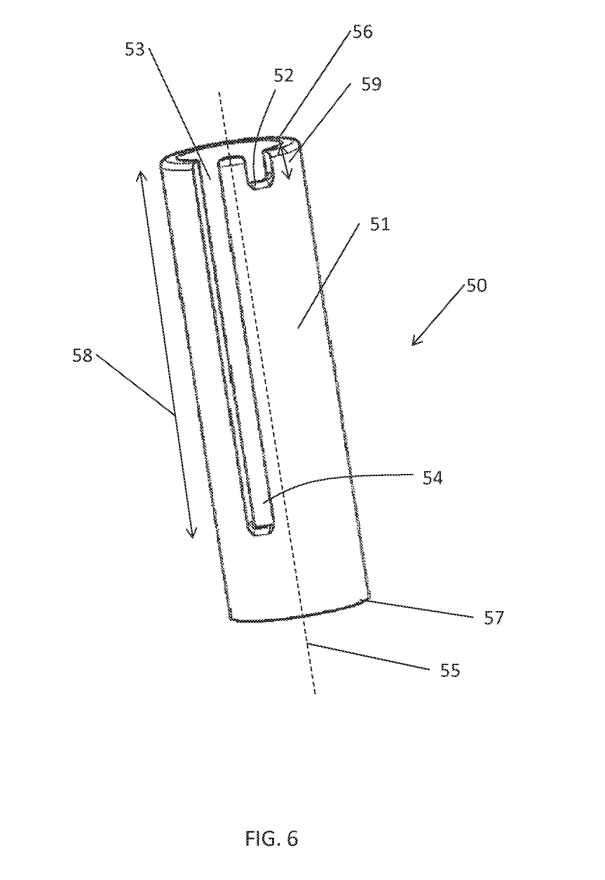

As shown in FIGS. 4 and 5, in one embodiment a sleeve 50 is coupled to the first plate 30 and defines one or more notches to position the pin 12 in one of a first or open position and a second or closed position. Referring further to FIG. 6, the sleeve 50 has a cylindrical wall 51 defining a passage 53 along an axis 55 of the sleeve 50 between a first or free end 56 of the sleeve 50 and an opposing second end 57 of the sleeve 50 coupled to the first plate 30. The passage 53 is coaxially aligned with the first opening 31. The sleeve 50 further defines a first notch 52 through the wall 51 and extending from the first end 56 of the sleeve 50 parallel with the axis 55 and a second notch 54 radially displaced along a circumference of the wall 51 from the first notch 52 and extending through the wall 51. The second notch 54 extends from the first end 56 of the sleeve 50 parallel with the axis 55. The second notch 54 has a length 58 different than a length 59 of the first notch 52.

In this embodiment, the sleeve 50 is sized to allow the pin 12 to pass freely through the passage 53. The pin 12 is rotatable within the sleeve 50 to align the alignment post 18 with one of the first notch 52 and the second notch 54. Further, the pin 12 is also configured to slide within the sleeve 50 to facilitate coupling the hitch assembly 10 to a cart. As shown in FIG. 4, the first notch 52 and the second notch 54 are sized to receive and support the alignment post 18. The first notch 52 is displaced in the vertical direction from the second notch 54. More specifically, in the embodiment shown in FIG. 4, the first notch 52 has a length 59 shorter than a length 58 of the second notch and, thus, the alignment post 18 is located closer to the handle 14 when positioned within the first notch 52 than if it were positioned within the second notch 54. While there are only two notches described here, it is understood that one notch or a plurality of notches can be used, where each notch allows the pin 12 to rest at a different distance with respect to the first end 56 of the sleeve 50. When the alignment post 18 is resting within the first notch 52, the pin 12 is retained in a first or open position and when the alignment post 18 is resting within the second notch 54, as shown in FIG. 5, the pin 12 is retained in a second or closed position.

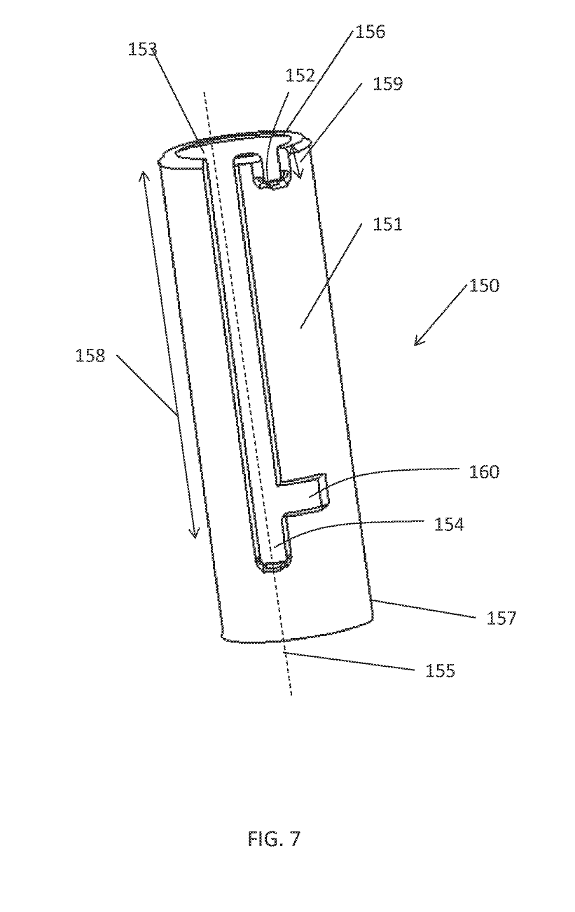

FIG. 7 illustrates an alternative embodiment of the sleeve 150. The sleeve 150 is generally constructed the same as the sleeve 50 described above, so only the differences in the sleeve 150 will be explained. In this embodiment, the sleeve 150 has a cylindrical wall 151 defining a passage 153 along an axis 155 of the sleeve 150 between a first or free end 156 of the sleeve 150 and an opposing second end 157 of the sleeve 150 extending from the first plate 30. The passage 153 is coaxially aligned with the first opening 31 of the first plate 30. The sleeve 150 further defines a first notch 152 through the wall 151 and extending from the first end 156 of the sleeve 150 parallel with the axis 155 and a second notch 154 radially displaced along a circumference of the wall 151 from the first notch 152 and extending through the wall 151. The second notch 154 extends from the first end 156 of the sleeve 150 parallel with the axis 155. The second notch 54 has a length 158 different than a length 159 of the first notch 152. A third notch 160 extends from a portion of the second notch 154. In one embodiment, the third notch 160 can extend in a direction perpendicular to the axis 155 or alternatively, the third notch 160 can extend in any angle with respect to the second notch 154. The third notch 160 is sized to accept at least a portion of the alignment post 18. When the alignment post 18 is rotated into engagement with the third notch 160, the alignment post 18 is locked from being able to move significantly in the vertical direction.

Referring back to FIG. 6, the pin 12 is movable between the closed position and the open position. For example, if the pin 12 of the hitch assembly 10 is in the closed position with the alignment post 18 resting in the second notch 54, the pin 12 can be moved to the open position by grabbing the handle 14 of the pin 12; pulling directly up on the handle 14; removing the alignment post 18 from the second notch 54 until the alignment post 18 clears the first end 56 of the sleeve 50; rotating the handle 14 towards the first notch 52 until the alignment post 18 is aligned with the first notch 52; and releasing the handle 14 so that the alignment post 18 falls into and rests within the first notch 52. Once the alignment post 18 is resting within the first notch 52, the hitch assembly 10 is maintained in the open position.

By maintaining the pin 12 in an open position, both hands of the user are free to more easily position a connecting device, such as a tongue of an incoming cart, into the hitch assembly 10. Furthermore, the hitch assembly 10 includes a larger base area to more easily accept the tongue of the incoming cart. The combination of the alignment post 18, the notched sleeve 50 and the larger base area of the hitch assembly 10 enable the user to keep both feet firmly on the ground while using both hands to position the incoming cart without having to hold the hitch assembly 10 in the open position.

In one embodiment, to attach a cart to the hitch assembly 10 when the hitch assembly 10 is in the open position, the user first positions the tongue of an incoming cart within the hitch assembly 10. With the tongue of the incoming cart positioned properly within the hitch assembly, the user: grabs the handle 14 of the pin 12; pulls directly up on the handle 14; removes the alignment post 18 from the first notch 52 until the alignment post 18 clears the first end 56 of the sleeve 50; rotates the handle 14 towards the second notch 54 until the alignment post 18 is aligned with the second notch 54; pushes the pin 12 slowly down towards the second notch 54; and once the alignment post 18 is aligned with the second notch 54, releases the handle 14 so that the alignment post 18 falls into and rests within the second notch 54. Once the alignment post 18 is resting within the second notch 54, the hitch assembly 10 is in the closed position.

In an alternative embodiment involving sleeve 150, a user can attach a cart to the hitch assembly 10 when the hitch assembly 10 is in the open position. To do so, the user first positions the tongue of an incoming cart within the hitch assembly 10. With the tongue of the incoming cart positioned properly within the hitch assembly, the user: grabs the handle 14 of the pin 12; pulls directly up on the handle 14; removes the alignment post 18 from the first notch 152 until the alignment post 18 clears the first end 156 of the sleeve 150; rotates the handle 14 towards the second notch 154 until the alignment post 18 is aligned with the second notch 154; pushes the pin 12 down towards the second notch 154 or allows the pin 12 to move downward as a result of gravity and/or the weight of the pin 12; rotates the alignment post 18 into alignment with the third notch 160; and once the alignment post 18 is aligned within the third notch 160, releases the handle 14 so that the alignment post 18 falls into and rests within the third notch 160. Once the alignment post 18 is resting within the third notch 160, the hitch assembly 10 is in the closed and vertically locked position.

In order to return to the open position from a closed position with the alignment post 18 resting in the third notch 160, the pin 12 can be moved to the open position by grabbing the handle 14 of the pin 12; rotating the handle 14 of the pin 12 radially towards the second notch 154 until the alignment post 18 is completely clear of the third notch 160 and located entirely within the second notch 154; pulling directly up on the handle 14; removing the alignment post 18 from the second notch 154 until the alignment post 18 clears the first end 156 of the sleeve 150; rotating the handle 14 towards the first notch 152 until the alignment post 18 is aligned with the first notch 152; and releasing the handle 14 so that the alignment post 18 falls into and rests within the first notch 152. Once the alignment post 18 is resting within the first notch 152, the hitch assembly 10 is maintained in the open position.

In one embodiment, a method of connecting a hitch assembly 10 to a cart includes providing a frame 20 having a base plate 22, a first plate 30 extending from a first edge portion 21 of the base plate 22 and defining a first opening 31, a second plate 32 extending from a middle portion of the base plate 22 and defining a second opening 33, and a third plate 38 extending from a second edge portion 23 of the base plate 22 and defining a third opening 39. The first opening 31, the second opening 33, and the third opening 39 are aligned. A pin 12 is provided having a handle 14 and an alignment post 18 extending radially outwardly from the pin 12, wherein the pin 12 is configured to be inserted through the first opening 31, the second opening 33 and the third opening 39. A sleeve 50 is provided defining a first notch 52 and a second notch 54 wherein the first notch 52 has a first length 59 and the second notch 54 has a second length 58 different than the first length 59. When the hitch assembly 10 is in a closed position and a user wishes to move to an open position, a handle 14 of the pin 12 is pulled to remove the alignment post 18 from within the second notch 54. The handle 14 is rotated towards the first notch 52 until the alignment post 18 is aligned with the first notch 52 and released so that the alignment 18 post falls into and rests within first notch 52.

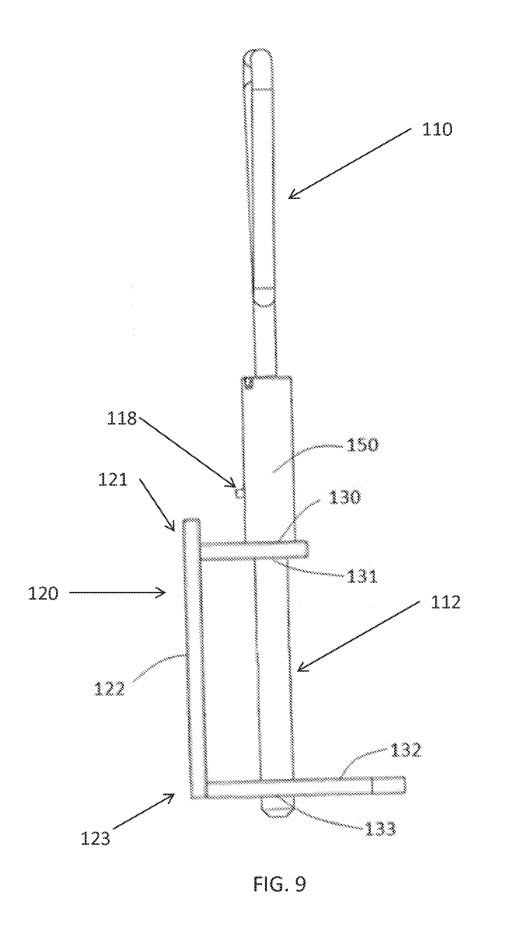

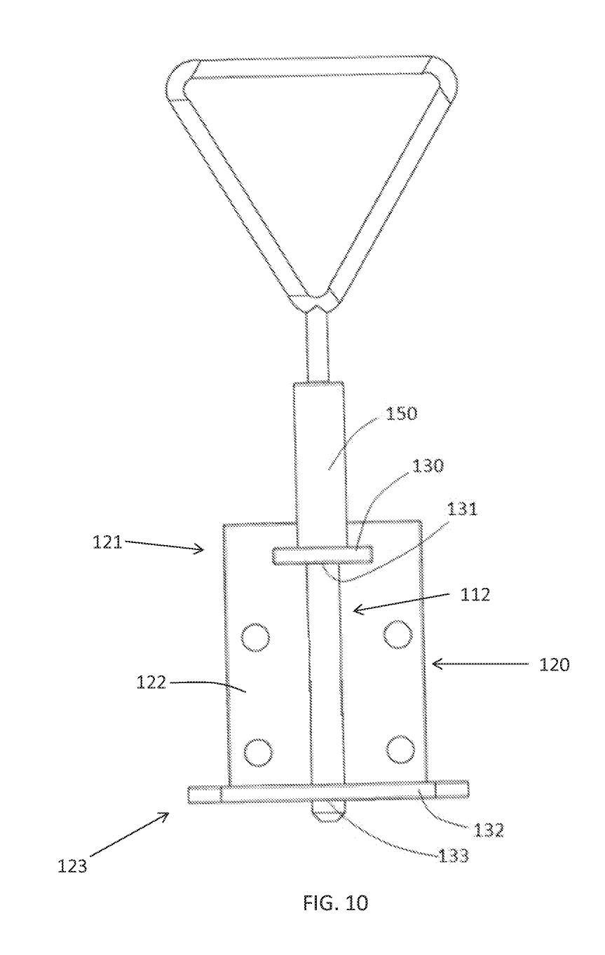

FIGS. 9 and 10 show an alternative embodiment of the hitch assembly 110. The hitch assembly 110 is generally constructed the same as the hitch assembly 10 described above, so only the differences in the hitch assembly 110 will be explained. The hitch assembly 110 includes a frame 120 having a base plate 122. The base plate 122 has a first edge portion 121 and a second edge portion 123. The frame 120 also includes a first plate 130 extending from the first edge 121 portion of the base plate 122 and defining a first opening 131, and a second plate 132 extending from the second edge portion 133 of the base plate 122 and defining a second opening 133 coaxially aligned with the first opening 131. The hitch assembly 110 further includes a pin 112 and a sleeve 150 which, in certain embodiments, are generally constructed the same as the pin 12 and the sleeve 50 (shown in FIG. 1), respectively.

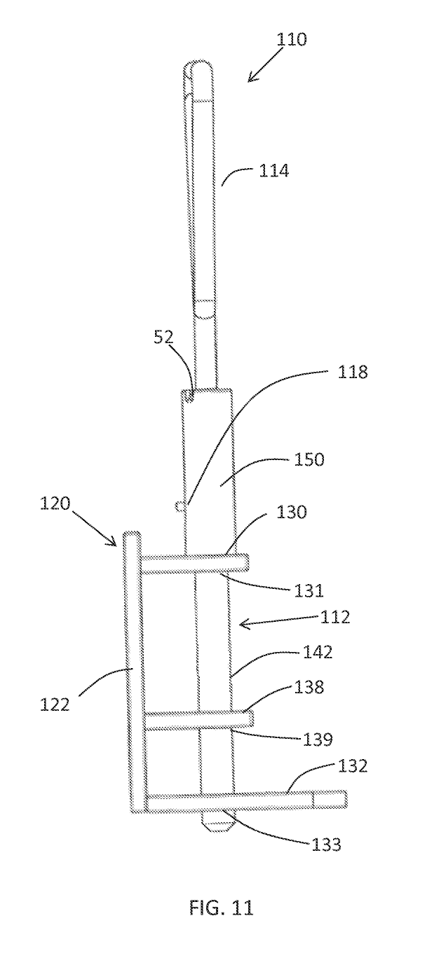

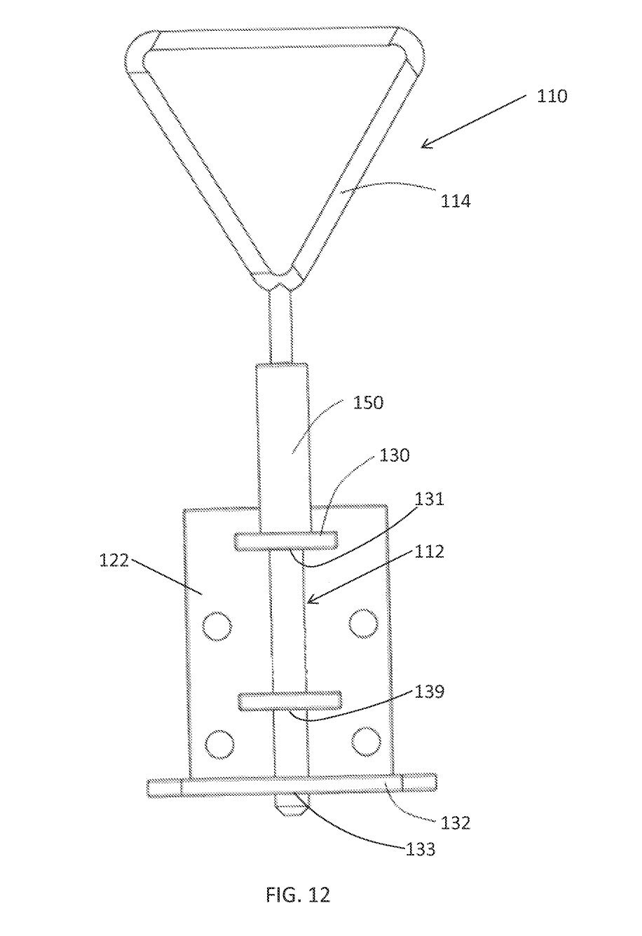

FIGS. 11 and 12 show a further embodiment of the hitch assembly including a third plate 138 similar to the second plate 32, shown in FIG. 1, positioned between the first plate 130 and the second plate 132 and extending from the base plate 122. The third plate 138 defines a third opening 139 coaxially aligned with the first opening 131 and the second opening 133. In an alternative embodiment, a biasing element (not shown), which can be a spring or other similar device, is positioned about the pin 112. This biasing element can be positioned between the first plate 130 and the third plate 138 or between the second plate 132 and the third plate 138. Further, in an alternative embodiment, a washer (not shown), similar to the washer 40, shown in FIG. 1, is positioned at a first end of the biasing element.

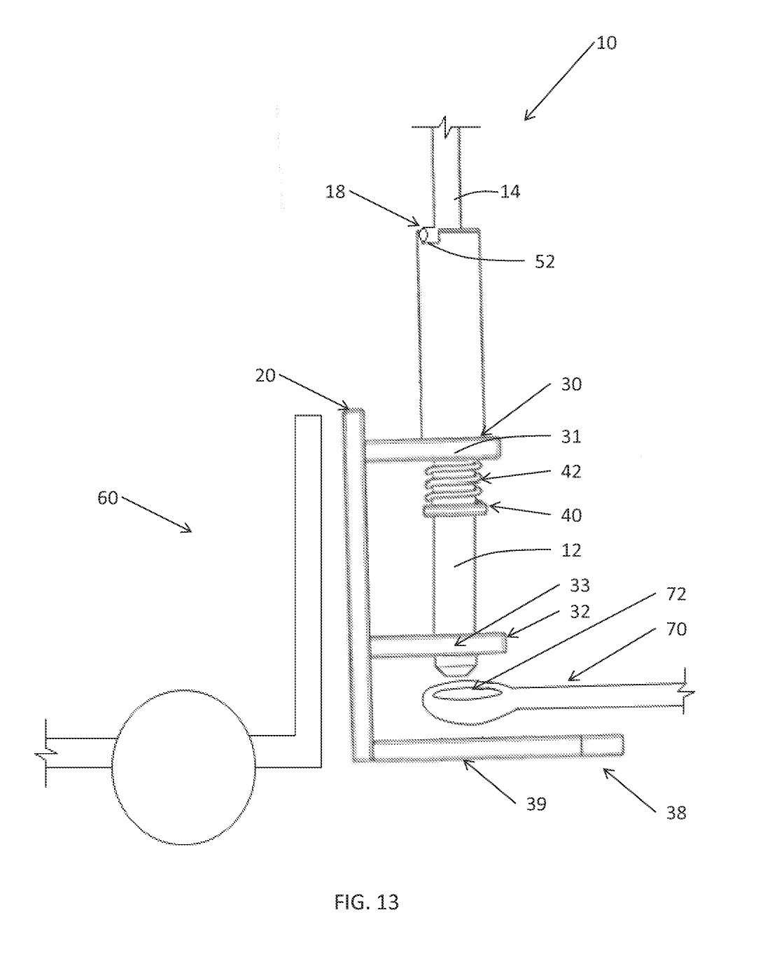

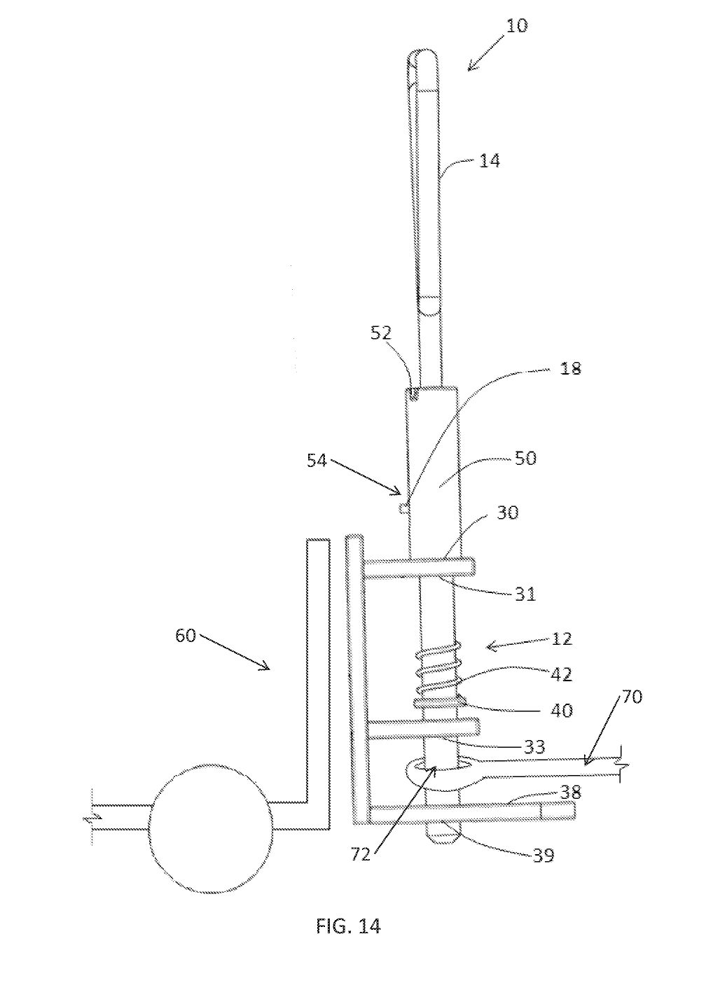

FIGS. 13 and 14 show one embodiment of the hitch assembly 10, a first cart 60 and a tongue 70 of a second cart (not shown). In this embodiment, the first cart 60 can be attached to the frame 20 of the hitch assembly 10 via openings 28 (shown in FIGS. 2-5). FIG. 13 shows the pin 12 of the hitch assembly 10 in the open position with the alignment post 18 resting in the first notch 52. In this embodiment, when the pin 12 is in the open position, the pin 12 is elevated in a vertical direction with respect to the frame 20. Because the pin 12 has been shifted vertically, it allows the tongue 70 of a second cart to enter an open space between the second plate 32 and the third plate 38. An opening 72 of the tongue 70 of the second cart be coaxially aligned with the first opening 31 of the first plate 30, the second opening 33 of the second plate 32, and the third opening 39 of the third plate 38. This coaxial alignment allows the pin 12 to pass through each of the first opening 31, the second opening 33, the third opening 39, and the opening 72 to hold the pin 12 within the first plate 30, second plate 32, third plate 38, and tongue 70 respectively. In this open position, the spring 42 is compressed between the first plate 30 and the washer 40.

FIG. 14 shows the pin 12 of the hitch assembly 10 in the closed position with the alignment post resting in the second notch 54 and the pin 12 holding the tongue 70 of the second cart in place. In this embodiment, when the pin 12 is in the closed position, the pin 12 has been lowered in a vertical direction with respect to the frame 20. As the pin 12 is lowered, it passes through each of the first opening 31, the second opening 33, the third opening 39, and the opening 72 to hold the pin 12 within the first plate 30, the second plate 32, the third plate 38, and the tongue 70 respectively.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Additionally, the features of various implementing embodiments may be combined to form further embodiments of the disclosure.

What is claimed is:

1. A hitch assembly comprising:
a frame including a base plate, a first plate defining a first opening wherein the first plate extends from a top portion of the base plate, a second plate defining a second opening wherein the second plate extends from a middle portion of the base plate, and a third plate defining a third opening wherein the third plate extends from a bottom portion of the base plate, wherein the first opening, the second opening, and the third opening are coaxially aligned;
a pin having a handle and an alignment post extending radially outwardly from the pin, wherein the pin is configured to be inserted through the first opening, the second opening, and the third opening; and
a sleeve coupled to the first plate and defining a first notch and a second notch wherein the first notch has a first length and the second notch has a second length different than the first length.

2. The hitch assembly of claim 1 further comprising a washer located between the first plate and the second plate and a spring positioned about the pin, wherein the spring is located between the washer and a bottom surface of the first plate.

3. The hitch assembly of claim 1 wherein the first length is configured such that when the alignment post is positioned within the first notch, the pin does not extend through the third opening.

4. The hitch assembly of claim 1 wherein the second length is configured such that when the alignment post is positioned within the second notch, the pin extends through the first opening, the second opening and the third opening.

5. The hitch assembly of claim 1 wherein the base plate defines a first base opening configured to receive a first protrusion formed on the first plate and a second base opening configured to receive a second protrusion formed on the second plate.

6. The hitch assembly of claim 1 wherein the base plate defines at least one opening configured to connect to a cart.

7. The hitch assembly of claim 1 wherein the sleeve further comprises a third notch extending from the second notch.

8. A hitch assembly comprising:
a frame including a base plate having a first edge portion and an opposing second edge portion, a first plate extending from the first edge portion of the base plate and defining a first opening, and a second plate extending from the second edge portion of the base plate and defining a second opening coaxially aligned with the first opening;
a sleeve having a cylindrical wall defining a passage along an axis of the sleeve between a first end of the sleeve and an opposing second end of the sleeve coupled to the first plate, the passage coaxially aligned with the first opening, the sleeve further defining a first notch through the wall and extending from the first end of sleeve parallel with the axis and a second notch displaced along a circumference of the wall from the first notch and extending through the wall, the second notch extending from the first end of sleeve parallel with the axis, the second notch having a length different than a length of the first notch; and
a pin having an alignment post extending radially outwardly from the pin, wherein the pin is movably positioned within the passage to position the alignment post in one of the first notch and the second notch.

9. The hitch assembly of claim 8 further comprising a third plate positioned between the first plate and the second plate and coupled to the base plate, the third plate defining a third opening coaxially aligned with the first opening and the second opening.

10. The hitch assembly of claim 9 further comprising a biasing element positioned about the pin and between the first plate and the third plate, and a washer positioned at a first end of the biasing element between the first plate and the third plate.

11. The hitch assembly of claim 8 wherein the pin is rotatable within the sleeve to align the alignment post with one of the first notch and the second notch.

12. The hitch assembly of claim 8 wherein the pin is slidably movable within the sleeve to facilitate coupling the hitch assembly to a cart.

13. The hitch assembly of claim 8 wherein the pin comprises a first end having a handle disposed at the first end of the pin to facilitate moving the pin.

14. The hitch assembly of claim 8 wherein with the alignment post positioned within the first notch, the pin is in an open position.

15. The hitch assembly of claim 8 wherein with the alignment post positioned within the second notch, the pin is in a closed position.

16. The hitch assembly of claim 8 wherein the pin comprises a second end having a chamfered edge at the second end of the pin to facilitate positioning the pin within the second opening.

17. The hitch assembly of claim 8 wherein the base plate defines an opening to facilitate coupling the hitch assembly to a cart.

18. A method of connecting an incoming cart to a hitch assembly coupled to a first cart, the hitch assembly including a frame having a base plate, a first plate extending from the base plate defining a first opening, a second plate extending from the base plate defining a second opening, and a third plate extending from the base plate defining a third opening coaxially aligned with the first opening and the second opening, and a sleeve coupled to the first plate and defining a passage coaxially aligned with the first opening, the method comprising:
moving a pin within the passage to a first position wherein an alignment post extending radially outwardly from the pin is retained within a first notch defined at a free end of the sleeve, in the first position the pin extending through the first opening and the second opening;
moving the pin with respect to the sleeve to remove the alignment post from within the first notch;
rotating the pin with respect to the sleeve to align the alignment post with a second notch defined at the free end of the sleeve, the second notch having a length greater than a length of the first notch; and
moving the pin within the passage to a second position wherein the alignment post is retained within the second notch, in the second position the pin extending through the first opening, the second opening, and the third opening to connect the incoming cart to the hitch assembly.

19. The method of claim 18 wherein moving the pin with respect to the sleeve to remove the alignment post from within the first notch comprises pulling up on a handle of the pin until the alignment post clears the first end of the sleeve.

20. The method of claim 18 further comprising placing a connecting device of the incoming cart between the second plate and the third plate before moving the pin with respect to the sleeve to remove the alignment post from within the first notch.

21. The method of claim 20 further comprising moving the pin downwards towards the second notch with the alignment post aligned with the second notch.

22. The method of claim 21 further comprising rotating the pin into a third notch in the sleeve extending from the second notch, until the alignment post rests within the third notch.
